(19) United States
(12) Patent Application Publication
(10) Pub. No.: US 2025/0001222 A1
(43) Pub. Date: Jan. 2, 2025

(54) A SURVIVAL DEVICE FOR FEEDING A STEADY SUPPLY OF BREATHABLE AIR INTO AN ENVIRONMENT

(71) Applicant: Safeback AS, BERGEN (NO)

(72) Inventors: Tor Berge, Søreidgrend (NO); Sigmund Andreassen, Sola (NO); Andre MJØLHUS, Bryne (NO)

(21) Appl. No.: 18/709,444

(22) PCT Filed: Nov. 9, 2022
(86) PCT No.: PCT/NO2022/050254

§ 371 Date: May 10, 2024

(30) Foreign Application Priority Data
Nov. 12, 2021 (NO) 20211364
Feb. 17, 2022 (NO) 20220224

(51) Int. Cl. A62B 33/00; A62B 7/00

(52) U.S. Cl. CPC A62B 33/00; A62B 7/00

(57) ABSTRACT

A survival device for feeding a steady supply of breathable air into an environment, including: a housing, the housing including: at least one inlet, at least one pump/fan, at least one power resource, a controller, and the survival device further including: at least one outlet wherein the at least one inlet is connected with a pump/fan inlet, and the at least one outlet is connected with the at least one pump/fan outlet via an air supply pipe, the air supply pipe having a rigid form factor, the outlet further includes an internal stiffening element for providing a stable and flexible form factor of the outlet.

### TECHNICAL FIELD

The present disclosure relates to a survival device for feeding a steady supply of breathable air into an environment. More specifically, the disclosure relates to a survival device for feeding a steady supply of breathable air into an environment as defined in the introductory parts of and claim 1.

### BACKGROUND ART

Snow avalanches in alpine and mountainous areas kill many people and animals each year, and have been the inspiration for development of many rescue and survival technologies. Some of these comprise radio equipment transmitting beacons of distress signals for aiding rescuers quickly to the right spot of the person in trouble. Other comprises floating devices, like airbags, for improving a person's ability to float on top of an avalanche in progress, and thus never become buried. Others again promote equipment comprising oxygen tanks and breading equipment.

The problems in prior techniques are that they are unreliable, for example because many require awareness of the person in need, and specific actions to be taken to make use of the equipment. Other problems relate to lack in sufficient efficiency, or they are too complex to wear/use.

Often the persons that are moving around in environments where there are risks of avalanches need to rely on more than one risk mitigating equipment. When the need for executing these types of equipment in an emergency, there is a problem to ensure that all equipment is properly activated. Time is limited when an accident occur, such as for example an avalanche.

It is the aim of the present invention to provide a solution reducing or eliminating one or more of the problems described above.

Most avalanche emergency kit products on the market today are aimed at finding an avalanche victim, preferable in time before the victim suffocates.

It is an object of the present disclosure to mitigate, alleviate or eliminate one or more of the above-identified deficiencies and disadvantages in the prior art and solve at least the above mentioned problem. According to a first aspect there is provided a survival device for feeding a steady supply of breathable air into an environment, characterized by comprising: a housing, the housing comprising at least one inlet, at least one pump/fan, at least one power resource, a controller, and the survival device further comprising: at least one outlet wherein the at least one inlet is connected with a pump/fan inlet, and the at least one outlet is connected with the at least one pump/fan outlet via an air supply pipe, the air supply pipe having a rigid form factor, the outlet is further comprising an internal stiffening element for providing a stable and flexible form factor of the outlet.

According to some embodiments, the at least one outlet further comprise arranged on its outer end: attachment means for fixedly arranging the at least one outlet to a position close to the users facial area.

According to some embodiments, the attachment means comprise gripping connectors for being arranged around a harness/strap.

According to some embodiments, the survival device comprises: an activation unit for activation of the pump/fan at an available/selected operation mode.

According to some embodiments, the survival device comprises: an activation lever, a bracket, a wire inside a wire sleeve, the wire sleeve being in a first end held by a wire sleeve space of a wire conduit element coupled to a bracket, the wire being connected in a first end to a fastening element comprised in the activation lever, and the wire sleeve being in a second end connected to the housing, the wire being connected in a second end to a connector being comprised in the housing, the connector being connected to the activation unit, such that when the activation lever is pulled relative the bracket, the pulling movement is transferred to the wire inside the sleeve to the connector and to the activation unit.

According to some embodiments, the activation lever and the wire conduit element further the survival comprises space for additional wires and wire sleeves for controlling activation of additional devices.

According to some embodiments, the housing comprises at least two battery connectors, and a battery enclosure lid.

According to some embodiments, the survival device comprises one or more sensors, wherein the sensors are sensitive to one or more of: movement caused by an avalanche, CO2 level above preset threshold, weight load/pressure, g-forces, power resource level such as battery capacity reserve, or sensor input crossing activation threshold such as: an oxygen content in a person's blood stream, heart rate or body temperature, and the one or more sensors is connected via a sensor input interfaces to the automatic activation unit of the controller, wherein the controller comprise a program for monitoring the sensor readings and for controlling the operation mode of the device accordingly.

According to some embodiments, the automatic activation unit comprise a manual switch/connector, wherein the manual switch/connector can override the sensor inputs and be used to manually activate the pump/fan at selected operation modus.

According to some embodiments, the additional wires and wire sleeves is used for controlling the activation of an inflating balloon/avalanche airbag.

According to some embodiments, the controller further comprising a communication device, the communication device being able to transmit device status to a remote communication unit.

According to some embodiments, the survival device comprises a comprehensive set of self-test programs comprising tests to check one or more of:
battery status
HW status
self-test control
fan status
operation status
communication status,
   and further signals for identify self-test program running and result.

Present disclosure relates to a further second factor: How to extend the survival time of an avalanche victim when being buried in the snow.

The present technology is based on the knowledge that the quality and content of for example breathable air in snow is sufficient for keeping a person alive for a long time. The challenge in for example instances where a person is buried in an avalanche is not the air content in the surrounding snow, but the fact that heat and condense of the air breathed out by the person creates a layer around the mouth and nose area which becomes either water saturated or, even worse, freezes to ice and thus becomes non-permeable for the air. The oxygen in the layers of snow on the opposite side of the non-permeable layer created by the breathing activity of the person thereby becomes unavailable for the person.

The authors of the present disclosure has further realized that most of the persons actually being victims of avalanches most often quickly lose control of limbs movement, for example the arms cannot operate any emergency equipment, or the victim may even be knocked unconscious in the process of being caught by an avalanche. Therefor most of the devices presented by the prior art, and certainly those techniques requiring physical activation procedures to be followed by the victim, is not very efficient or even fails completely to work in a real life situation.

The survival device described in present disclosure reduces, and may even eliminate, required conscious action of the victim, and operates as long as the device receives sufficient power. It further relies on the abundancy of breathable air comprised in the surroundings of the victim.

A rule of thumb in avalanche operations is that 9 out of 10 avalanche victims may stay alive for approximately 15 minutes before the risk of dying from a lack of oxygen supply becomes inevitable. Unless an air pocket is present in front of the victims face, it is likely the victim eventually suffocate by inhaling the same air he/she exhale.

The goal of the devices in present disclosure is to significantly increase the survival time, up to 90 minutes or more, so that the odds are better for the victims, and that the time for rescue crews to find the victim in time increases.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

Breathable air is used in this document to illustrate one type of embodiments, but it should be understood that the device may be used in a variety of environments.

### BRIEF DESCRIPTION OF THE DRAWINGS

FIG. 1—Conceptual diagram of invention

FIG. 2—Conceptual diagram of invention; dual channel

FIG. 3A—One embodiment of inventive concept, stand-by

FIG. 3B—Backpack system of invention

FIG. 4—Illustration of inventive concept, activated.

FIG. 5—Alternative usage cases: snow cave and tent

FIG. 6—Method flow chart

FIG. 7—System description

FIG. 8—Backpack embodiment, multiple inlet channels

FIG. 9—Backpack and helmet

FIG. 10—Backpack side mounted embodiment of invention

FIG. 11—Details of side mounted embodiment of invention

FIG. 12—Skier wearing backpack embodiment of invention

FIG. 13—Driver of snowmobile wearing embodiment of invention and helmet.

FIG. 14—Victim of avalanche wearing embodiment of invention in a backpack

FIG. 15—Survival device in a standalone embodiment

FIG. 16A—Show a side view of the clean air intake side of the survival device of FIG. 15

FIG. 16B—Show an end view of the clean air intake side of the survival device of FIG. 15

FIG. 16C—Show a side view of the clean air outlet side of the survival device of FIG. 15

FIG. 17A—Show a use form of the survival device of FIG. 15

FIG. 17B—Show a use form of the survival device of FIG. 15

FIG. 17C—Show a use form of the survival device of FIG. 15

FIG. 18A and 18B—Show an embodiment of the internal elements arranged in the bottom half of the house of the clean air intake side of the survival device of FIG. 15

FIG. 19—Show details of the clan air outlet side of the survival device of FIG. 15

FIG. 20—Show details of the clan air outlet side of the survival device of FIG. 15

FIG. 21—Show details of the clan air outlet side of the survival device of FIG. 15

FIG. 22—Show an example of a pull pin arrangement for releasing the activation lever

FIG. 23—Show an embodiment of user on a snow mobile.

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

The present invention will now be described in more detail with reference to the non-limiting drawings.

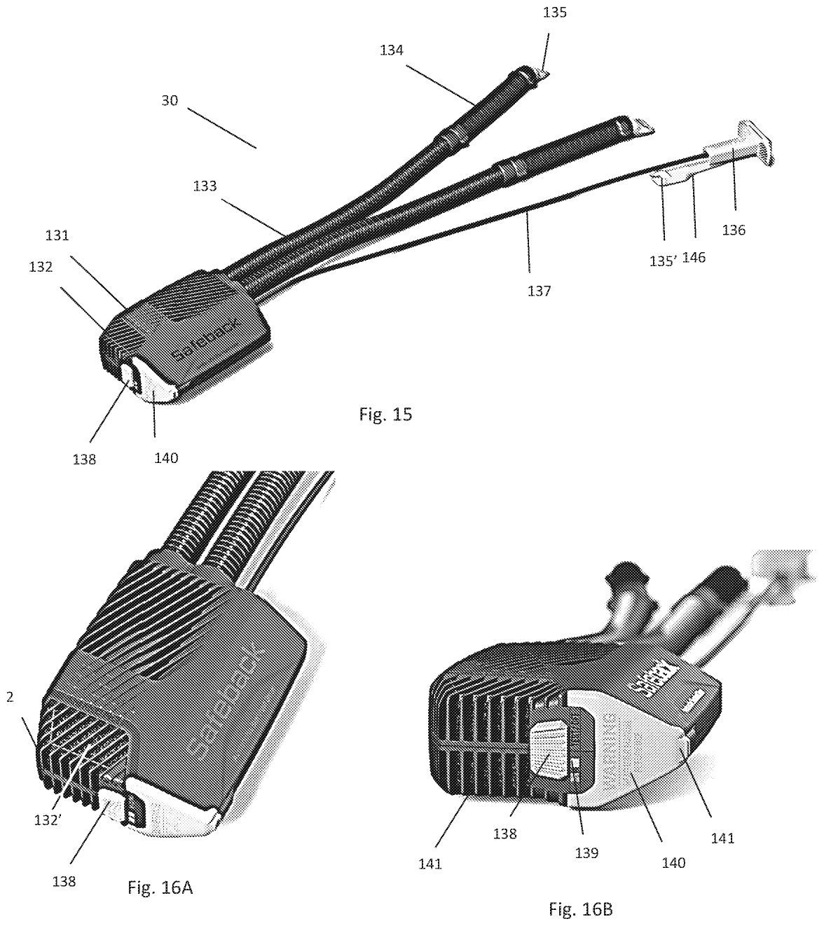

FIG. 15 to FIG. 23 shows details of the device 30 according to present invention and disclosure. In one use case the survival device is used as a survival device aiding the user to get a steady supply of breathable air when entrapped by snow in an avalanche. Although some of the features are discussed only in some embodiments of this disclosure, it shall be understood that any feature may be combined and included in any of the embodiments discussed. It should also be understood that any of the features discussed in any of the embodiments may be left out without the embodiment itself leaving the inventive concept.

Snow is diffuse, so even in a large avalanche, where the snow becomes compact, it is possible to get air from the device 30 according to present disclosure through the snow even if the distance is more than 25 cm between the mouth and the nearest air outlet 134.

The first aspect of this disclosure shows a survival device 20,30,40,60 for feeding a steady supply of breathable air into an environment, characterized by comprising: a housing 131, the housing 131 comprising: at least one inlet 4,83,120,132, at least one pump/fan 3,85,170,171, at least one power resource 5,121,150, a controller 6,182, and the survival device 10,20,30,40,60 further comprising: at least one outlet 1,80,134 wherein the at least one inlet 4,83,120,132 is connected with a pump/fan 3,85,170,171 inlet, and the at least one outlet 1,80,134 is connected with the at least one pump/fan 3,85,170,171 outlet via an air supply pipe 7″,89,133, the air supply pipe 7″,89,133 having a rigid form factor, the outlet 1,80,134 is further comprising an internal stiffening element 144 for providing a stable and flexible form factor of the outlet 1,80,13.

In short the device 30 according to present disclosure is an advanced controlled pump/fan 170, 171 located in a housing 131 that draws air in from the snow via an inlet 132. From this pump/fan 170, 171, one, two or more pipes/hoses 133 is arranged to transfer the air pumped by the pump/fan 170, 171 to air outlets 134 provided at the end of the one or more hoses/pipes 133. These outlets 134 output air that then passes through the snow around the facial area and reaches mouth and nose of the victim. It is a vital element that the hoses/pipes 133 are provided in a material and rigid form factor that may withstand high pressure from surrounding snow without collapsing. At the same time the hoses/pipes 133 advantageously are form flexible in the sense that they are bendable to be arranged over a shoulder from the lower back to the upper front side of a user. An alternative is to provide rigid fixed form hoses/pipes 133 of a form individually pre-shaped to a person. The clue is to provide air passage from the pump/fan 170, 171 to the air outlets 134 that is not being deformed by snow pressure or other objects applying outside pressure/squeeze on the hoses/pipes 133.

The device 30 according to present disclosure is powered by robust batteries (for example AA batteries which withstand cold better than rechargeable batteries) and is triggered via an activation lever 136.

The total weight of the device 30 according to present disclosure may vary according to components requirement, lifetime expectancy, operation time requirements (battery pack, fan, etc.) but it is a target to minimize the weight, and a reachable target is to provide the device 30 according to present disclosure at less than 900 grams, and more advantageously at around 400 grams.

The device 30 according to present disclosure requires no action from the user/victim under operation. Once the device 30 according to present disclosure is to be activated, automatically or by pulling the activation lever 136, it will supply air to the victim regardless if the victim is conscious or not.

The novel activation lever 136 of the device 30 according to present disclosure may activate more security devices in the same activation action that involves pulling the lever 136, such as an avalanche balloon. This is achieved by a unique lever 136 design comprising housing for multiple wiring being operated by the same lever 136. Meaning that when pulling the lever 136 more than one device will be activated.

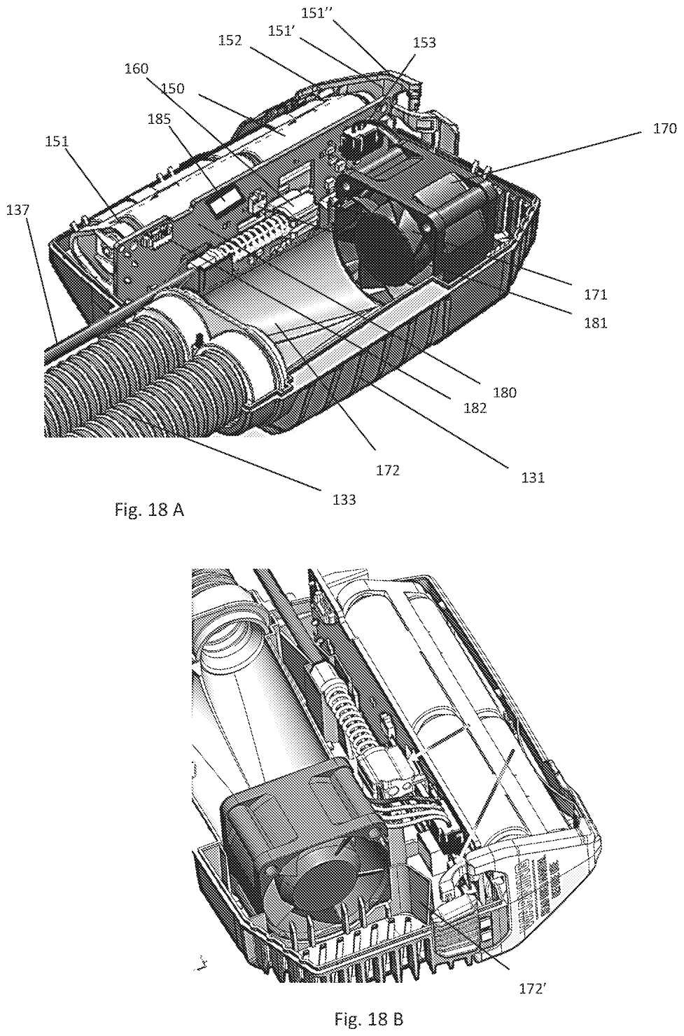

In FIG. 15 of the device 30 according to present disclosure the lever 136 is seen to be arranged on a bracket 146, and the bracket comprise fastening means 135′ for fastening to clothing or gear such as a harness or back pack. The lever is arranged at a first end of a wire 137′ arranged inside a sleeve 137, where the second end of the wire is connected to a wire connector 160 inside the survival device house 131, as evident form FIG. 18A and 18B showing a lower portion of the internal of the house 131. The upper portion of the house 131, may be detachable mounted with the lower portion, such that the house 131 may be separated in two parts for service and inspection. The device 30 according to present disclosure further comprise two air supply hoses/pipes 133 being in a first end connected to the survival device house 131, and in the second end connected to the device outlets 134. The hoses/pipes provides a conduit from the fan and fan air guide 172 through the hoses/pipes 133 and to the device outlets 134. The portion of the fan air guide 172 shown in the figure is only the longitudinal lower half of the air guide. The internal of the upper half of the house 131 comprise an upper portion of the fan air guide 172, such that when the lower and upper portion of the house 131 is mounted, the fan air guide 172 comprise an air tight channel for the air between the outlet of the fan and the inlet of the hoses/pipes 133. On the side of the fan 170 inlet portion of the house 131, it may be provided an air separation foil 172′ for securing that no air surrounding the component print card 180 or battery compartment is able to escape into the fan inlet channel. The device outlets 134 are designed to output air provided by the fan motor 170 and fan 171 arranged inside the survival device house 131. The at least one outlet 1,80,134 may comprise, arranged on its outer end, attachment means 135 for fixedly arranging the at least one outlet 1,80,134 to a position close to the users facial area. The attachment means 135 may comprise gripping connectors 145 for being arranged around for example a harness/strap.

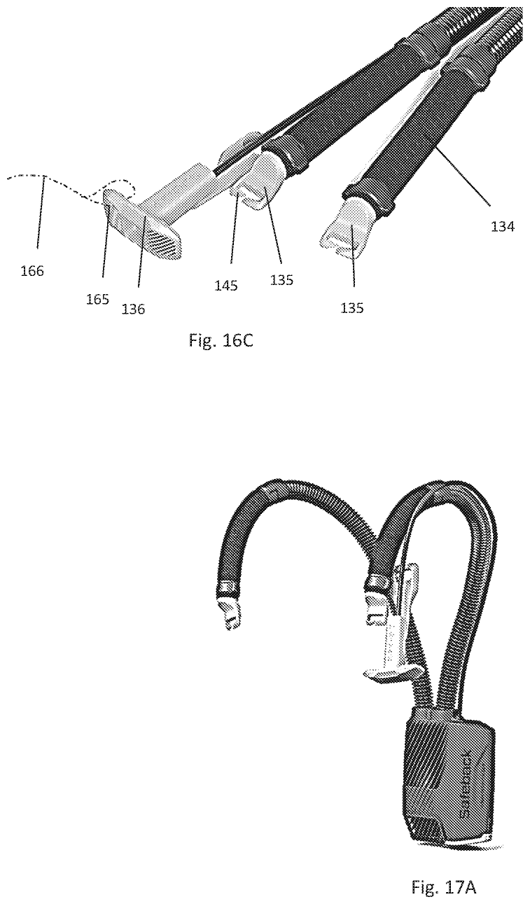

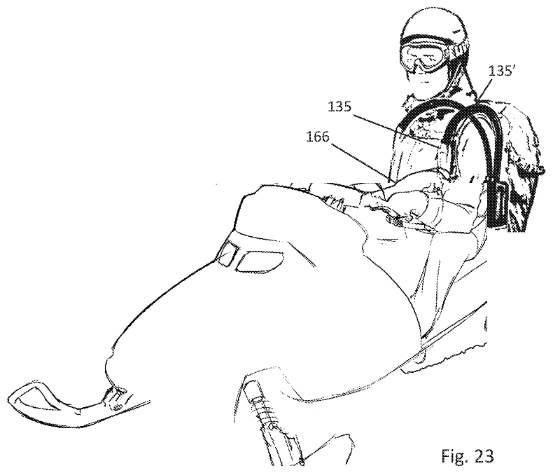

In a further embodiment it is provided an optional attachment means 165 for a safety tether 166 on the activation lever 136 as seen indicated on FIG. 16C. The safety tether 166 is in one end fastened to the attachment means 165 arranged on/in the activation lever, and in the other end to an anchor point arrangement on for example a snowmobile, snow trail machine, or the like as exemplified in FIG. 23. When the user drives through a high risk environment, and the survival device 20,30,40,60 is set in a standby mode, the safety tether 166 will start the survival device 20,30,40,60 if the driver is separated from the vehicle without releasing the safety tether 166 from the vehicle anchor point, such as for example when the user and vehicle is being taken by an avalanche.

In yet a further embodiment the safety tether 166 may be attached to a safety pin (not shown) holding a biased activity switch for activation of the activation unit 181 which when the safety pin is pulled activates the fan 171 if the mode selector has been set in standby mode. The biased activation switch may be arranged in the activation lever holding a safety tether activation wire, the safety tether activation wire being connected to a stretched spring arrangement with a switch connected to the activation unit, such that when safety pin is pulled out of its arrangement in the activation lever 136, the safety tether activation wire will let go of its hold on the spring arrangement and the switch connected to the activation unit 181 will activate the survival device 20,30,40,60. In an arrangement as exemplified in FIG. 22 the safety pin may for example hold back a press tensioned coil spring arrangement in the activation lever that will when the safety pin 167 being pulled, the activation lever 136 will be pushed out of it passive state into an active pull state, such that the wire will be pulled in a similar pull action as being drawn by the user, and the survival device 20,30,40,60 is activated.

In a further embodiment the safety tether 166, and or the safety pin 167 may be, instead of being coupled to the activation lever, have a corresponding activation module arranged in the housing closer to the activation unit 181 (not shown), and the safety tether 166 being connected directly on this activation module. The activation module may be comprising similar or equivalent features as discussed above in combination with the activation lever.

The housing 131 of the survival device 20,30,40,60 may comprise at least two battery connectors 151,151′, and a battery enclosure lid 140.

The FIG. 15 also shows a few details of the survival device house 131, such as the battery enclosure lid 140, and an operation mode selector/self-test button 138. The operation mode selector/self-test button 138 may enable the user to turn the device 30 according to present disclosure on, and/or off, and for example select a functional self-test mode. Other modes may be provided and selected. The survival device house 131 also is provided with a grid patterned air inlet 132. The grid pattern may be in various forms and the intention is to let air in, but keep obstacles and snow out of the air intake. The version shown in the figures show grilles. In one embodiment the device 30 according to present disclosure is set in a standby mode upon inserting batteries in the battery holder, and then can be activated anytime by pulling the lever.

In FIG. 16A and FIG. 16B of the device 30 according to present disclosure it is shown in more detail the battery enclosure lid 140, and a battery enclosure lid lock 141. The battery enclosure lid lock 141 provides safety features for resisting accidental opening of the battery enclosure lid 140.

The operation mode selector/self-test button 138 provides selection of operation mode, and one or more operation mode indicator led 139 indicates the mode of operation selected. In FIG. 16A it is shown an inlet filter 132′ inside the grid patterned air inlet 132. The inlet filter 132′ is provided to further secure an obstacle free interior of the fan and fan motor.

FIG. 16C Shows in detail the clean air outlet side of the survival device 30, wherein the outlet attachment means 135 is arranged on the outer end of the device outlets 134. The attachment means 135 is used for fixedly arranging the at least one outlet 134 to a position close to the users facial area. This arrangement can be one of, but not limited to: a harness/backpack strap, a gear coupler arrangement on jacket/harness/backpack coupling strap band/quickdraw sling or similar.

The outlet attachment means 135 has in this embodiment gripping connectors 145 for being arranged around for example a harness/strap, such as a shoulder strap of a custom harness or a backpack or the like. Various attachment alternatives may be chosen, not shown here, and not limited by: click lock connector, zipper connector, Velcro type attachment, Carabine hook, and others.

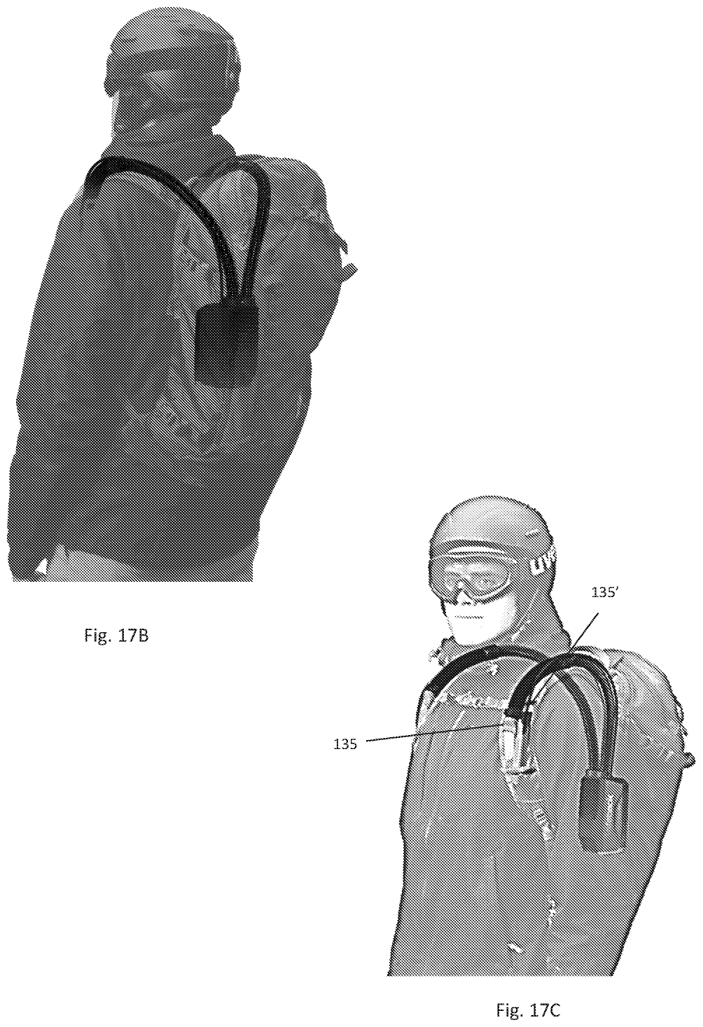

FIG. 17A shows the device 30 according to present disclosure in a form as if being arranged over the shoulders of a user. It emphasizes the flexibility of the hoses/pipes, and exemplifies the multitude of use scenarios wherein the device 30 according to present disclosure may be deployed.

One such deployment is shown in FIG. 17B and FIG. 17C wherein the device 30 according to present disclosure is arranged together with a backpack or for example an avalanche balloon/avalanche airbag device.

In FIG. 18 of the device 30 according to present disclosure the internal layout of the survival device house 131 is shown in an example embodiment. The various components may be recognized as the batteries 150 held by the in the battery connectors 151, 151′, a component print card 180, a fan motor 170, a fan 171, a fan air guide 172, wire connector 160 wherein a second end of a wire 137′ arranged in the wire sleeve 137 is connected, and other. The batteries 150 powering the components in the device house 131. Other power sources may be provided, such as a remote battery pack carried separate from the device house 131, and being in wired or wireless power transfer contact with the components of the device house 131. The batteries may be rechargeable via a charging port and wiring (not shown), or exchangeable. The outer battery connector 151′ may be held in place by a battery security lock feature 151″ for securely holding the batteries in place when battery enclosure lid 140 is closed.

The component print card 180 may comprise power circuitry 153, wherein a power backup reserve, for example a capacitor or small rechargeable battery, may be comprised. A controller/processing device 6, 182 is comprised and provides processing and HW/SW for running programs and routines, GPS-like device, cell phone and other features.

The survival device 10, 20, 30, 40, 60 may comprise an activation unit 181,11 for activation of the pump/fan 3,85,170,171 at an available/selected operation mode. The wire connector 160 may typically be connected to the activation unit 181 which when the lever is operated activates the fan 171 if the mode selector has been set in standby mode.

The device 30 according to present disclosure may also comprise a variety of sensors 152, 185, sensors that may be one of, but not limited to: gyro, vibration, pressure/vacuum, moisture, power, temperature, CO2, Oxygen, light, noise or other.

The survival device 20,30,40,60 may comprise one or more sensors 8,152,185, wherein the sensors are sensitive to one or more of: movement caused by an avalanche, CO2 level above preset threshold, weight load/pressure, g-forces, power resource level such as battery capacity reserve, or sensor input crossing activation threshold such as: an oxygen content in a person's blood stream, heart rate or body temperature, and the one or more sensors 8,152,185 are connected via a sensor input interfaces 8′ to the automatic activation unit 11,181 of the controller 6,182, wherein the controller 6,182 may comprise a program for monitoring the sensor 8,152,185 readings and for controlling the operation mode of the device 10,20,30,40,60 accordingly.

The automatic activation unit 11,181 may comprise a manual switch 11′/connector 160, wherein the manual switch 11′/connector 160 can override the sensor 8,152,185 inputs and be used to manually activate the pump/fan 3,85,170,171 at selected operation modus.

Typically, in one embodiment the user will analyze the environment, and if moving into a high risk environment activate or put in a standby mode the survival device 10, 20, 30, 40, 60 for the duration of the period being in the high risk environment.

Alternatively the activation unit 181, 11 may be controlled by the controller/processing device 6, 182 being receiving sensor 8, 152, 185 data, such that the controller/processing device 6, 182 may be configured to activate the device when an emergency situation is detected.

Typically the controller then will automatically activate the survival device 10, 20, 30, 40, 60 when the detecting that the survival device 10, 20, 30, 40, 60 is at a complete standstill, optionally together with detector data conforming to a situation where the survival device 10, 20, 30, 40, 60 is buried in snow, and the bearer is at a complete standstill/nonmoving. This is a typical situation for a user if buried in an avalanche. The time to manually activate a safety device is extremely short, and very often not possible. Once buried in an avalanche, the user will rarely be able to move a single body part, and being able to reach a switch or similar is very unlikely. Thus, the embodiment of the survival device according to present disclosure of the survival device may automatically activate and start the deice when a user is taken by an avalanche and buried in the snow, unable to move or manually activate the device.

Alternatives when the automatic sensor driven activation shall not work is when for example the user place his/her survival device 10, 20, 30, 40, 60 at rest when stopping for a break and other. Then, the device will be at absolute standstill, but sensor data may for example identify that the device is at rest in a daylight area, in a heated room, or in a cupboard with plenty of Oxygen. In these circumstances the device shall not be activated. Other scenarios may be detected where the device is not to be activated.

A separate switch (not shown) may be used to deactivate/pause the device when short term stops are planned/executed.

The controller 6, 182 may comprise power saving features, and provide for several pump/fan power levels to be uses/selected. This may be automatically controlled, for example based on power left in the power sources 150, or manually, either by the user or a remote controller.

The survival device 10, 20, 30, 40, 60 may comprise: an activation lever 136, a bracket 146 a wire 137′ inside a wire sleeve 137, the wire sleeve 137 being in a first end held by a wire sleeve space 149′ of a wire conduit element 149 coupled to a bracket 146, the wire 137′ being connected in a first end to a fastening element 147 comprised in the activation lever 136, and the wire sleeve 137 being in a second end connected to the housing 131, the wire being connected in a second end to a connector 160 being comprised in the housing 131, the connector 160 being connected to the activation unit 181,11, such that when the activation lever 136 is pulled relative the bracket 146, the pulling movement is transferred to the wire 137′ inside the sleeve 137 to the connector 160 and to the activation unit 181,11.

The activation lever 136 and the wire conduit element 149 may further comprise space for additional wires 137′ and wire sleeves 137 for controlling activation of additional devices. The further additional wires 137′ and wire sleeves 137 may be used for controlling the activation of an inflating balloon/avalanche airbag.

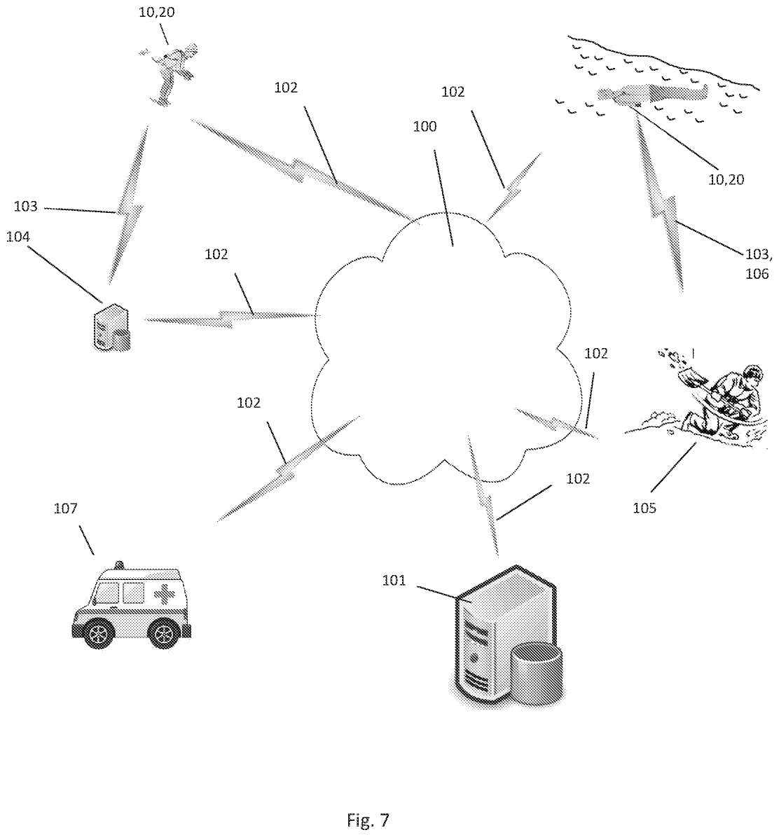

The device 10, 20, 30, 40, 60 controller 6 may further comprise a communication device, wherein the communication device being able to transmit device 10, 20, 30, 40, 60 status to a remote communication unit 101, 104, 105, 107. The communication device may be physically separate from the device itself, for example a smartphone running an app that communicate with the device via a short range communication channel, such as bluetooth, NFC or other. The app or remote communication unit may be set up to communicate distress signals and device data to one or more emergency services. Emergency services may be first helpers arriving at the scene of an avalanche, a medical unit, a localization service, or other. Various emergency services are illustrated in FIG. 7.

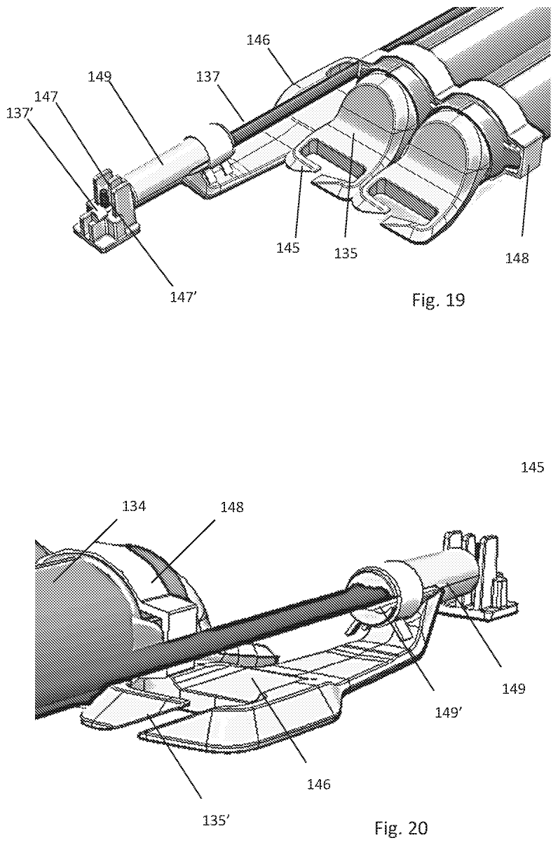

FIG. 19 show the clean air outlet side of the survival device 30 wherein the activation lever 136 internal layout is exemplified as it may be provided in one embodiment. The wire 137′ being arranged inside the wire sleeve 137 is in a first end connected to the wire fastening elements 147 being comprised by a slim passage 147 and optionally a fastening screw 147′, such that when the activation lever is operated the wire will be moved relative the wire sleeve 137, and the wire 137′ movement is relayed to the connector 160, which in turn will trigger the activation unit 181. The wire 137 typically will have a wire stopper knob at the periphery end. On the bracket 146 it is further arranged a wire conduit element 149, arranged to receive and hold the wire sleeve 137 when wire 137′ is puled ad moved inside the wire sleeve 137. This figure also show an outlet clamp 148 being arranged to fasten the air outlets 134 to the bracket 146.

FIG. 20 shows the other side of the clean air outlet side of the survival device 30 and the activation lever 136 as seen in FIG. 19. Here it is revealed how there is made room for further wires/activation elements may be connected in the unoccupied wire and wire sleeve space 149′ in the wire conduit element 149.

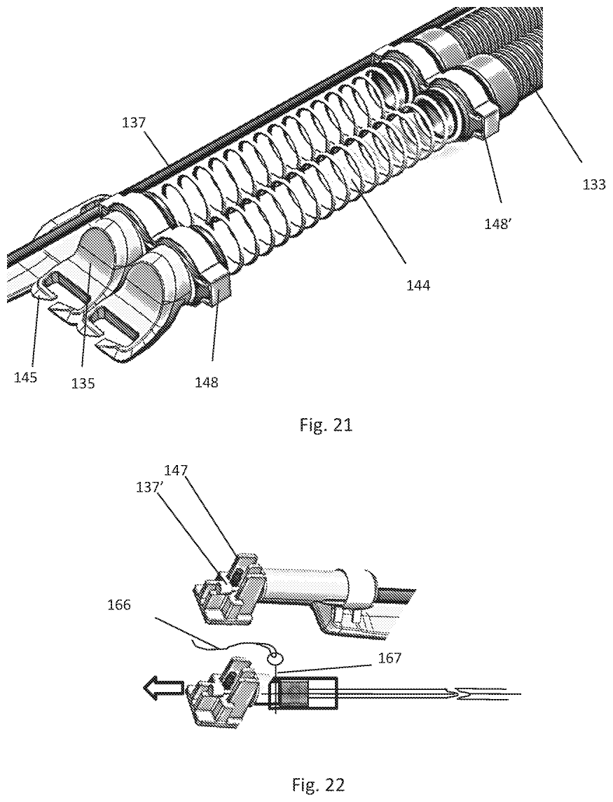

In FIG. 21 of the device 30 according to present disclosure the internal of the air outlet 134 is shown in one alternative embodiment. A stiffening element 144 is arranged at the outlet of the hose/pipe 133. The function of the stiffening element 144 is to provide a stable and flexible form factor of the air outlet such that when pressure of ice and snow is applied outside the air outlet, the form remains in a shape that is able to deliver air to the environment. A second outlet clamp 148′ is shown to provide even better connection between the two hose/pipes 133 of this embodiment. It is an alternative to separate the hose/pipes 133 as seen in previous figures, and then none or maybe only one hose/pipe 133 is connected to a bracket.

The survival device 10, 20, 30, 40, 60 may further comprise a comprehensive set of self-test programs comprising tests to check one or more of:
battery status
HW status
self-test control
fan status
operation status
communication status,
   and further signals for identify self-test program running and result.

The self-test programs may be implemented in the controller, the remote device or any of the modules defined in the present disclosure. The self-test may be executed at startup of the device, in between active use, upon request from on board SW, or according to predefined self-test intervals provided by remote app programs or the like. Typically the self-test result will be stored or communicated to a remote service/storage. If the self-test detects any operational hazards, or other faults, the self-test routine may initiate appropriate mitigating activities. Such as alarm sounding to signal need for battery charging/replacement, loss of communication, faulty fan or other. See below.

I one embodiment the led lights 139 may operate to signal the messages as follows, but not limited to, and the messages are given for example when new batteries are inserted, or when the self-test button is pressed:

OK NEW BAT: Green light on for 10 seconds, ending with a short beep. Indicates new and good lithium batteries and ok hardware.

OK USED BAT: Green light blinking for 10 seconds, ending with a short beep. Indicates good batteries and ok hardware.

BAT LOW: Red light blinking for 10 seconds, ending with three short beeps. Indicates that batteries should be changed but the trip can be completed.

BAT DEPLETED: Red light on for 10 seconds, ending with one steady beep for 5 seconds. This Indicates that batteries must be changed immediately.

FATAL ERROR: Red steady light and beeping buzzer sound. Indicates hardware failure. Unit must not be used. Beeping (250 ms on, 250 ms off) and red light continues until the self-test button is pressed again, or after 20 seconds.

When the operation mode selector/self-test button 138 is used as a self-test button, the

Self-test may be initiated by removing and re-inserting batteries, or pressing the self-test button for >1 sec. One example of this may comprise that the fan is ramped up for ca 1 seconds, running at 100% for 3 seconds and ramping down over 1 second. Error conditions are checked, and an indication is given on LEDs and buzzer after the test. During self-test the indications OK NEW AT, OK USED BAT or BAT LOW is given, depending on the battery status.

Other features that may be implemented and operated may comprise, but is not limited to:

### Use-Cases

### Inserting New Lithium Batteries

Inserting new Li batteries (10.74V) should start a fan self-test and give the indication “OK NEW BAT”. This action is logged and used to reset the battery capacity estimation. After new batteries are inserted, the reported capacity on the serial port should be 100%.
(LI batteries will have 1.79-1.83V. The six cells will have 10.74V to 10.98V. With a 5% error margin, the limit should be 10.2V (1.7V*6). Alkaline batteries have <1.65V*6=9.9V.)

### Inserting Used Li Battery With Estimated Remaining Charge >80% and Battery Voltage >9.3V

Inserting batteries with voltage above 6*1.55V=9.3V, and the estimated remaining charge above 80%.
The indication “OK USED BAT” should be given. The self-test is automatically run,
(This is the normal scenario after traveling with airplane, when one must remove batteries while on the plane. It also happens when alkaline batteries are inserted)

### Self-Test With Estimated Remaining Charge >80% and Battery Voltage 9.3-10.2V

The indication “OK USED BAT” should be given. The self-test is automatically run
(1.55V cell voltage is indicating a recovered but depleted cell. A good cell that has been very recently loaded heavily will also drop below 1.55V but will recover in 5-10 minutes.)

### Inserting Battery With Estimated Remaining Charge 70-80% and Battery Voltage 9.3-10.2V

The indication “BAT LOW” should be given. The self-test is automatically run

### Self-Test With Estimated Remaining Charge 70-80% and Battery Voltage 9.3-10.2V

The indication “BAT LOW” should be given. The self-test is automatically run (Indicates that batteries should be changed but the trip can be completed. This also happens when alkaline batteries are inserted)

### Inserting Batteries With Voltage <9.3V or Estimated Remaining Charge <70%

The message “BAT DEPLETED” should be given. The fan self-test is not performed.
(1.55V cell voltage is indicating a recovered but depleted cell. A good cell that has been very recently loaded heavily will also drop below 1.55V but will recover in 5-10 minutes.)

### Battery Dropping Below 7.8V During Fan Self-Test

During fan self-test, if the voltage drops below 1.3V×6=7.8V, the “BAT DEPLETED” indication should be given
(A cell loaded with 1A will typically drop to 1.45V after a few seconds. If it drops below 1.3V*6=7.8V, it indicates a cell with less than 25% remaining. This assumes room temperature.)

### Insertion of Rechargeable Lithium-Ion Cells or Lithium Thionyl Chloride Cells

These cells will damage the fan and/or electronics. If a battery voltage above 11.5V is detected, the unit should give the FATAL ERROR indication, and the fan self-test is not performed.

(If the fan is turned on, it will almost certainly destroy some component. The unit might fail even without turning on the fan. But we should at least try to give an alarm to the user)

### Release Button Activated During Self-Test

If the release button is depressed during self-test, the-self test should be aborted, and normal release operation started. This is to happen both during fan running, and during alarm after test.

### Self-Test With Missing Tacho Signal.

This could be due to a blocked fan or a broken connection to the fan. (Pin 4). At start-up, the indication is determined by battery state as shown above. After 2 seconds without tacho signal, the “FATAL ERROR” indication is given.

### Self-Test Button Operation When the Unit is Not Activated

Pressing the self-test button for less than 1 second should not start self-test. Pressing the self-test button for more than 1 second should initiate self-test.

### Self-Test Button Operation When the Unit is Activated

Pressing the self-test button for less than 1 second should do nothing. Pressing the self-test button for more than 1 second should abort operation and enter sleep mode.

### Fan Restart on Fan Failure

If the fan stops (or does not start) after it has been activated, the unit will try to restart it.

If the tacho signal has been below 1% for 3 seconds, the power is removed for 3 seconds, and then full power is applied again for 3 more seconds. This sequence repeats until the fan starts to work.

(This can be tested by blocking the fan before activating it. The supply current will briefly rise to 0.5-2A each 3 seconds. Remove the blocking and verify that the fan starts operating normally. Press Self-test button for 2 sec to verify that it can be stopped. Verify log entries.)

### Battery Interruption During Operation (Activated)

It is possible that the battery connection is interrupted due to vibration or mechanical shock. A very short interruption while the fan is operating will reset the processor and stop the fan.

It is advantageous that the fan to continue operation after interruption. To achieve this, the CPU will check the log. If a manual start was the last entry in the log, the CPU will automatically start fan operation again.

(Tested by pulling the release trigger and disconnect the battery, and then reconnect it again. The duration of the disconnect is not important. 1-2 seconds is ok. Verify that the operation starts again. This test should be repeated at least two times).

### Initiation of Production Test Mode

A way to initiate factory production tests is provided, since it is impossible to do after the unit is distributed. We choose detect test-mode by checking if the PWM and TACHO pins are shorted together. This is not possible when a fan is connected.

If a short is found, the firmware will enter factory test mode, and commands are expected on the serial port. If no commands are received, the self-test will terminate automatically after 30 seconds, and start normal operation.

(Tested by connecting the pins, applying power and observe no fan operation until after 30 seconds).

### Discharge Estimation

The discharge status of the battery can be estimated from the log. Assuming the clock is running all the time. The discharge consists of three parts:
Sleep time consumption. 0.0005 Ah pr day
Self-test consumption: 0.003 Ah pr test.
Release time: 1.0 Ah pr hour.

The times here can be found by scanning the log. If the time has been reset because the battery has been removed for some time, the only error will be in the sleep time, which is not contributing much compared to the other factors.

The capacity of the battery is ca 3.5 Ah. (Based on Energizer L91 batteries).

(This function is difficult to test, except for the fan operation time. One alternative is to insert fake data into the log via the serial port. The fan can be run for 2 hours, and we then test if the alarm is given during self-test

Some test scenarios are:
The power was briefly interrupted during operation, causing the RTC clock to restart
The number of self-tests is very high, exhausting the battery
Shelf time has been very long (>5 years))

Log events

| | |
|---|---|
| NEW_BATTERY (1) | A new battery is inserted (power up). This also |
| | indicates that the real-time clock has been reset. |
| SELF_TEST_OK (2) | The self-test has finished without errors |
| LOADED_BAT_LOW (3) | The battery voltage during self-test |
| | with fan running was too low (<1.4 V) |
| CHARGE_LOW1(4) | Estimated remaining charge was 70-80% of capacity |
| CHARGE_LOW2(5) | Estimated remaining charge was below 70% of capacity |
| BAT_DEPLETED (6) | The unloaded initial battery voltage was too |
| | low or estimated remaining charge <70% |
| RELEASE_MAN (7) | The unit was activated by pulling the release handle |
| RELEASE_AUTO (8) | The unit was activated by the accelerometer/altimeter (not used yet). |
| TERMINATED (9) | The operation was aborted by the user pressing the self-test button |
| FAN_SLOWDOWN (10) | This event happens the first time the battery voltage drops below 5.5 V, and the |
| | fan PWM starts to be reduced. It indicates that the battery was almost depleted. |
| AUTO_RESTART (11) | This event is stored when we have had a short break in the |
| | battery connection and the unit detected that it had been |
| | released and should continue operation without self-test. |
| FAN_RUNNING (12) | During fan operation (activated unit) this event is stored each minute |
| | of operation. This is used for battery capacity estimation. |
| FAN_FAILED (13) | Fan tacho was not detected. Something wrong with the fan. |
| OVERVOLTAGE (14) | A battery was inserted with >1.85 V pr. Cell |
| FAN_RESTART (15) | Auto restart of the fan was performed. |

### Log Size and Overflow Handling

The log is currently 5300 entries long, using the 64 k processor (the smallest available). The space is enough for ca 2500 self-tests. That is almost 7 years of use each day.

If current is logged each minute it is released, we can store data for 41 hours. This translates to ca 20 avalanches!

When the log is close to full, the oldest data should be erased. The last new-battery event must not be erased.

(Should be tested as part of the regression testing, using a script to fill up the log)

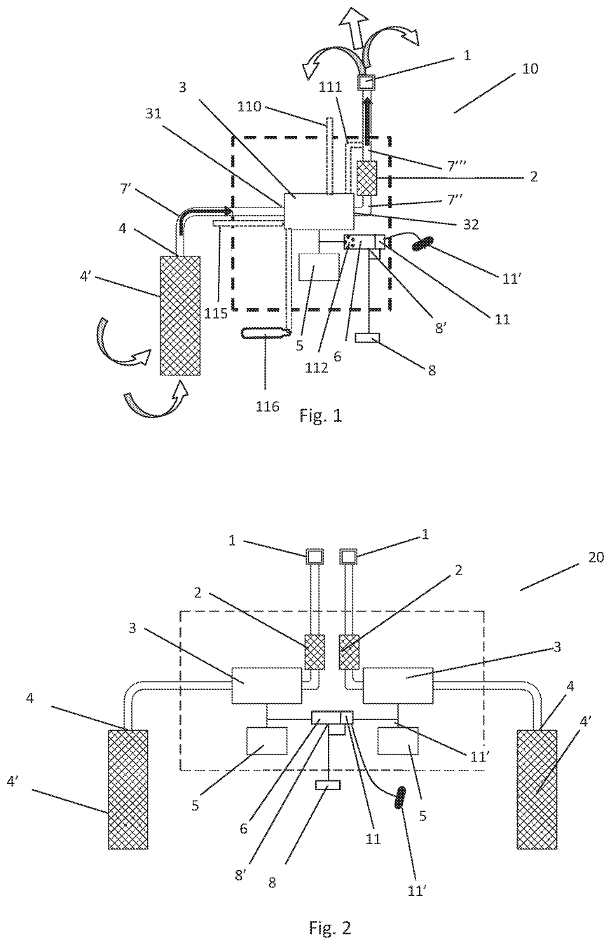

Now, earlier versions of the devices depicted in FIG. 1 to FIG. 14 is in the following sections of the disclosure included for reference, and for which all features may independently be combined with the features of the device 30 according to present disclosure described above.

In one embodiment of the earlier version of the device in present disclosure as outlined in FIG. 1, the breathable air quality improvement device 10 comprise at least an inlet 4, a pump 3, a power source 5 and an outlet 1, and a pipe or conduit 7′, 7″, 7′″ connecting the elements for providing a path for flow of a breathable air, from the inlet 4, via the pump to the outlet 1. The pump 3, when activated by sufficient power from a power source 5, such as a battery, will provide a flow of breathable air from the inlet 4 to the outlet 1.

The at least one inlet 4 is connected to a pump inlet 31 of the pump 3, and the at least one outlet 1 is connected to a pump outlet 32 of the pump 3, the pump may when activated pump air from the inlet 4 to the outlet 1.

The pump may be activated by a controller 6 which may be comprised of a manual switch 11′ or automatic activation unit 11. Typically the controller 6 comprises an avalanche situation detection mechanism/sensor 8, which automatically activates the switch 11, and thus activates the breathable air quality improvement device. The avalanche situation detection mechanism/sensor 8 may be overridden to activate breathable air quality improvement device 10, 20 in non-avalanche situation where improved breathable air quality is wanted.

A manual switch 11′ may be arranged to be latched onto a carrying strap of the breathable air quality improvement device 10.

The pump may be operated in more than one mode, for example high, medium and low, where the low mode can be a power save mode. The controller 6, 182 may comprise detectors and activators for automatically regulation of mode of operation of the pump, for example as a result of power resource capacity, such as battery capacity reserve, detected by a detector (not shown). As an example only, this may be facilitated such that the pump 3 has full effect until 50% of power resource remains, and switches automatically to medium mode which lasts until 25% of the power resources remain, and then the mode of pump operation automatically switches to a power save mode, low mode.

The mode of pump operation selection may be manually selected by a local or remotely connected regulator switch 11′.

Such a mode controlling regime may prolong the operation time considerably when a limited power resource capacity for the breathable air quality improvement device 10 is available.

In a further alternative embodiment of the earlier version of the device in present disclosure as illustrated in FIG. 2, a dual breathable air quality improvement device 20 is provided. In such a system the capacity of the breathable air, such as air provided may be increased to be adapted to an environment requiring distributed load of the environment around the inlets 4. For example in an emergency situation where a person is trapped in a snow avalanche, the surrounding snow may not provide sufficient amount of air/oxygen in one spot only, and it may be necessary to provide inlets in more than one location.

The invention may have multiple numbers of instances of breathable air quality improvement device 10 arranged to work together to improve the quality of breathable air in an environment around the outlets 1.

Another reason for duplicating or having a plurality of breathable air quality improvement devices 10 may be redundancy. An arrangement providing redundancy may also comprise a test function implemented in for example the controller 6. The test function frequently tests the operation status of a main breathable air quality improvement device 10, and if an operation malfunction is detected activates another breathable air quality improvement device 10 available in the redundancy setup.

A controller 6 in a redundancy setup with multiple breathable air quality improvement devices 10 may serve all or some of the breathable air quality improvement devices 10, as indicated in FIG. 2. It shall be understood that the controller in other embodiments may be arranged in more than one device, for example one for each breathable air quality improvement device 10, 20, or the operation switch 11 may be comprised in a multifunction unit 6, whilst sensors 8 may be arranged in a separate module/device, and may be organized in unique modules/devices for each breathable air quality improvement device. If there is more than one controller 6, it may be possible to couple these in a hierarchical way, such that for example a secondary controller may be the first to identify an emergency situation, and activation of the first air quality improvement devices 10 may be initiated by this. Sensors may be connected to one, more or all controllers 6 in a hierarchical setup. These setups may increase the redundancy capacity.

The breathable air quality improvement device 10 may improve the quality of output breathable air by comprising a filter 2 for cleansing the breathable air. The filter may be arranged to be in the pipe or conduit 7′, 7″, 7′″, for example in the outlet pipe 7′″. The filter may be arranged at locations of the breathable air quality improvement device 10, for example in the inlet duct 7′.

When air is supplied by the breathable air quality improvement device 10, a typical filter may be a CO₂ filter. Other filters may be provided, such as for example water/snow/ice removal filter.

In one embodiment of the invention, the breathable air quality improvement device 10, 20 comprise a feedback duct 110, for fetching air from the space around the outlet 1 and recirculate it through the pump (3) and CO₂ filter (2). The controller 6 may control the operation of the feedback duct 110 supplying air to the pump 3 when the level of CO₂ detected in the outlet 1 area reaches a preset level.

The filter(s), such as a CO₂ filter, may for different reasons be malfunctioning, and prohibit air flow through the filter. One embodiment of the breathable air quality improvement device 10, 20 may comprise a bypass duct 111, which is activated by the controller 6 to supply air directly from the pump to the outlet 1 when the filter is detected to be malfunctioning, for example by detecting a lower than expected flow of air through the pump. Other sensors may detect malfunction of the filter(s). The bypass duct 111 may also be activated when for example air quality level in the outlet 1 surroundings are safely below critical levels and the air flow through the pump 3 has acceptable quality.

A typical CO₂ filter may be chosen to have a capacity of many times the possible air volume pumped by available power resource 5, such as battery.

Power resource 5, may be comprised of a battery, or other power generating device, for example a fuel cell instead of or in combination with a battery.

A typical embodiment of the breathable air quality improvement device 10 will also comprise an inlet 4 comprising an inlet protection device 4′ for protection of the inlet against being clogged by snow, water or other substances. The inlet protection device may be formed by a light weight protection mesh, for example by a hard plastic or carbon material, and the mesh may be filled with a gas permeable material such as a polyurethane sponge or other. In a further embodiment the inlet protection device 4′ will be gas permeable, but fluid non-permeable. The protection device may be shockproof.

The outlet 1 may be arranged in wearable device/equipment 114 to ensure a position close to nose/mouth of person wearing the breathable air quality improvement device 10, 20. Wearable device may comprise a fastening device (not shown) arranged on for example the jacket collar/the backpack strap or inside for example a helmet.

Now a typical embodiment of a breathable air quality improvement device 10 will be discussed.

A typical use for the breathable air quality improvement device 10 of the invention is to provide an emergency pack for mountaineers spending time in avalanche prone areas. In an avalanche situation, a person trapped below the surface of the snow has oxygen supply from the surrounding snow only a maximum of a few minutes. The snow itself will in most cases comprise sufficient oxygen surplus for a person to be able to survive, if the person could access the oxygen enclosed in the snow in the vicinity of the mouth/nose. This is however not the case, since condense from the breath of the person buried in the snow very quickly saturates the surrounding environment around the head with humidity, which very often creates an ice layer or water saturated layer transforming the close by snow to a non-permeable material. This non-permeable shell around the mouth/nose area will prohibit the oxygen from the close by snow volume to reach the buried person, and the person will very quickly suffocate because of the CO₂ buildup in the breathing environment. To carry an oxygen supply for emergency use might postpone the inevitable outcome if the victim is not rescued, but it is cumbersome to carry oxygen supplies able to supply life sustaining oxygen for a long period.

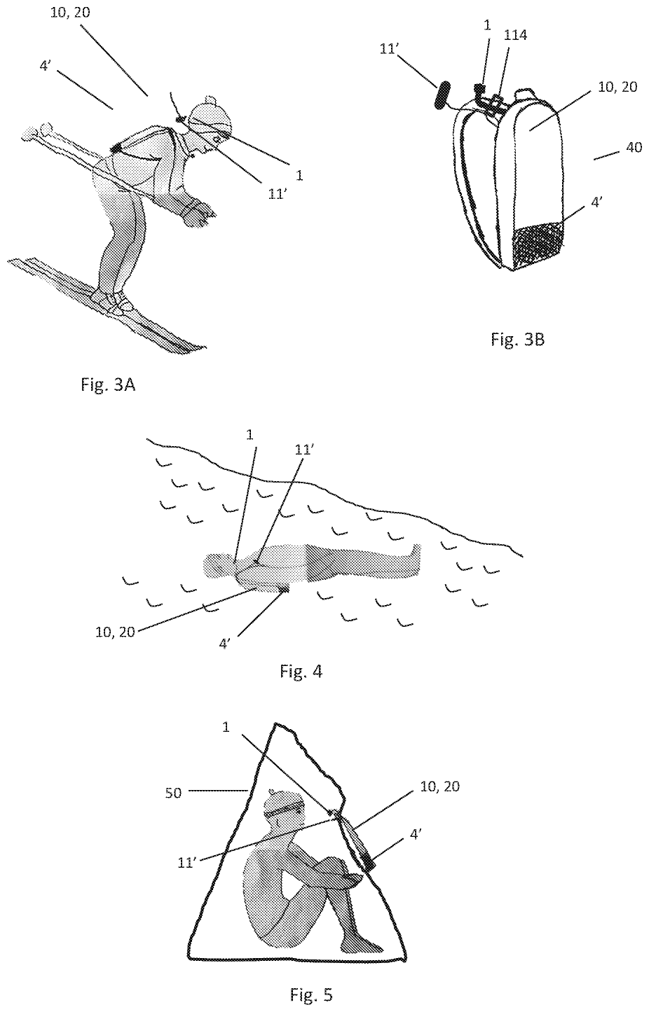

FIG. 3A illustrates the breathable air quality improvement device 10 of the earlier version of the device in present disclosure worn by a skier/mountaineer as a backpack 40. A backpack 40 assembly is illustrated in one embodiment in FIG. 3B. The backpack 40 provides an inlet 4, 4′ environment away from the face area of the backpack 40 wearer. The outlet 1 is arranged to be located close to the face area of the backpack 40 wearer. The pump 3, power source 5, such as a battery, and controller 6 may be arranged inside the backpack 40.

The backpack 40 comprising the breathable air quality improvement device 10, may further provide a protective case around the parts of the invention to avoid malfunction due to external forces or impacts. The pipe and/or the conduit 7′, 7″, 7′″ may be designed to be resistant to bending and also enforced to avoid breakage or leaks when the wearer is in an emergency situation, such as when caught by an avalanche or when buried under snow.

The breathable air quality improvement device 10 of the invention is typically in one of: shut off, stand by or active state.

When shut off, typically when stored, none of the elements of the air quality improvement device 10 are active.

When in a stand by state, the breathable air quality improvement device 10 controller 6 is monitoring status of the switch 11, both the automatic activation unit and the manual on/off switch 11′. If either is activated, the controller 6 starts the pump 3, and air is pumped from the inlet 4 to the outlet 1. The air quality improvement device 10 has switched into the active state.

The controller 6 may comprise a gyrosensor 8, that will detect a movement pattern equal to what would be expected to be caused by an avalanche. For example if the bearer is caught by an avalanche as exemplified in FIG. 4, the automatic activation unit may be activated by the gyrosensor 8, and the controller starts the pump 3. The pump will pump air form the inlet 4 on the backside of the person carrying the backpack 40 to the outlet 1 close to the face area, and thus transfer oxygen from the surroundings, outside the ice layer or water saturated layer to the face area of the victim. This way the ice barrier built up by the victimized persons breathing will not prohibit the environment around the face to close the access to the surrounding oxygen rich air contained in the snow. The pumped airflow will also displace the CO₂ saturated air around the nose and mouth.

In such an instance there will be advantageous if the inlet is arranged as far from the nose and mouth area of the bearer, for example as low as possible in the backpack 40. The inlet 4 would further improve efficiency if the inlet was enclosed by an inlet protection device 4′ such as a filter or material preventing the snow to be packed closely around the inlet. The bigger the area of the inlet protection device 4′ is, the more surface is provided for catching air from the surrounding snow.

When the breathable air quality improvement device 10, 20 is activated and an ice layer is built up around the head region of the victim the CO₂ level will quickly increase in the berating environment. The breathable air quality improvement device 10, 20 may advantageously comprise one or more filters 2 for purifying the air, such as filter for catching CO₂. Filters 2 may be arranged close to the outlet 1, but could also be arranged close to the inlet 4 for prohibiting “bad” air to pollute the inflow air quality.

Optionally, the controller 6 may also initiate a distress signal transmitter, not shown, and other signal transmitting devices or visual/physical tracking devices, not shown. The optional transmitter may even transmit data from the various sensors 8 of the breathable air quality improvement device 10, 20, such as from sensors provided in the device 10, 20 for measurement of power level, filter status, operation malfunctions.

In an optional embodiment the breathable air quality improvement device 10, 20 is provided with one or more sensor input interfaces 8′, for connection to for example body attached sensors 8, able to detect physical condition of the person carrying the breathable air quality improvement device 10, 20. The controller 6 may be able to process and optionally convey the information to a remote communication unit 101, 104, 105, and also receive control instructions from the remote communication unit 101, 104, 105 as illustrated in FIG. 7. The controller may be able to alter the level of air supply through the breathable air quality improvement device 10, 20 based on changes or levels in the data provided by the sensors 8.

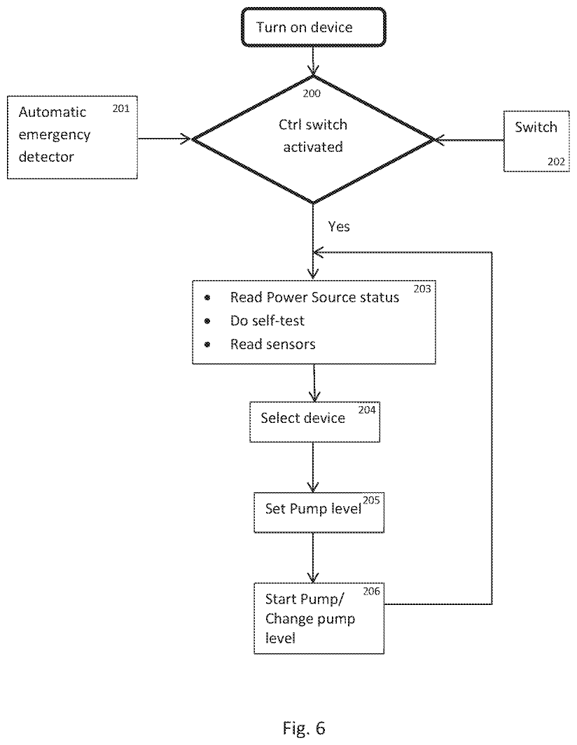

The breathable air quality improvement device 10, 20 can be adapted for a number of advantageous usage scenarios such as the above discussed backpack 40 for avalanche emergency use. The backpack 40 or other, such as a bag, embodiments of the breathable air quality improvement device 10, 20 could be optimized for use in for example an emergency snow-cave or tent camp 50 as exemplified in FIG. 5. If a skier or the like is for example surprisingly caught by a storm, and time allows only digging a rude/shallow snow cave, the air supply may be a critical factor for survival. The breathable air quality improvement device 10, 20 could then be used to fetch air from away from the face area by either providing an extendable outlet pipe 7″, 7′″ such that the breathable air quality improvement device 10, 20 could be arranged outside the shallow snow cave, and the extendable outlet pipe 7′″, 7′″ could be arranged close to the face area of the skier, or providing an extendable inlet pipe 7′ which could be placed in a sufficient distance from the face area, for example from the outside of the cave/tent 50, and further a manual switch 11′ of the controller 6 may be provided to switch the breathable air quality improvement device 10, 20 to desired pump mode. Depending on the volume of free space the person in distress has been able to dig around himself, the mode of operation may be variably set to provide sufficient air supply, but at the same time save energy for longest possible use.

Other uses may for example be tent 50 which may be buried in snow in a snowstorm, thus closing normal ventilation features. The inlet may be extended to the outside far enough to fetch air supply form outside the ice buildup around the tent cloth.

The automatic activation unit 11 may be triggered of a various detected events, for example by one or more sensors/detectors 8 connected to the automatic activation unit 11, comprising but not limited to: movement caused by an avalanche, CO₂ level above preset threshold, weight load/pressure, g-forces, or other sensor 8 input crossing activation threshold such as: an oxygen content in a person's blood stream, heart rate or body temperature, or other.

In one embodiment wherein the invention is used as a backup oxygen supply device, for example when a person is spending time in a shallow snow cave. A person spending time in an environment with high CO₂ content might not realize the danger, and may suffocate. The earlier version of the device in present disclosure, breathable air quality improvement device 10, 20, may comprise a sensor 8 for CO₂ content and upon reaching a level considered dangerously low automatically start supplying air fetched from outside the restricted area. The breathable air quality improvement device 10, 20 may additionally comprise an alarm 112, such as a sound alarm, visible light alarm or other, the alarm 112 may be activated by the controller 6 to alert the person of the detected dangerous level of CO₂. The alarm 112 may be incorporated in the controller 6 or be arranged as a separately connected alarm device. The alarm 112 may ensure a better power use scheme of the breathable air quality improvement device 10, 20, since it may enables the user or controller 6 to switch the breathable air quality improvement device 10, 20 on and off, manually or automatically, based on the quality of air in the outlet 1 area.

In a further embodiment of the earlier version of the device in present disclosure the breathable air quality improvement device 10, 20 can be used in combination with one or more further lifesaving equipment features/devices, such as for example a balloon/avalanche airbag safety device which is provided to inflate in a snow avalanche situation. The further lifesaving equipment may be controlled by the automatic activation unit 11 of the breathable air quality improvement device 10, 20, or by the manual switch 11′ of the breathable air quality improvement device 10, 20. Other further lifesaving features may be for example: distress beacon radio signal, emergency flash light, sirens, or other.

In a further embodiment of a breathable air quality improvement device 10, 20 wherein a combination with a balloon/avalanche airbag safety device which is activated by expansion of oxygen from a compressed O₂ tank, it is provided an additional inlet 115 arranged to connect the inside of the balloon/avalanche airbag with the pump 3, wherein the flow of oxygen from inside the balloon/avalanche airbag is opened when the balloon/avalanche airbag has been filled with oxygen, and surplus of oxygen from the other inlets 4, 4′ is not providing sufficient oxygen flow through the breathable air quality improvement device 10, 20.

In yet a further embodiment of a breathable air quality improvement device 10, 20, a container 116 filled with compressed oxygen may be added to provide oxygen through the pump when the inlet 4, 4′ is not providing enough oxygen. The additional supply may be controlled by the controller and sensors identifying unacceptable levels arranged on the inlet 4, 4′measuring flow rate or oxygen level or in the outlet environment measuring CO₂.

In yet a further embodiment of a breathable air quality improvement device 10, 20, the balloon/avalanche airbag backup feature vis additional inlet 115 and the additional container 116 holding compressed oxygen may be combined to provide even further operation time span of the breathable air quality improvement device 10, 20.

In yet a further embodiment of a breathable air quality improvement device 10, 20, a second life saving equipment may be arranged to co-work with the breathable air quality improvement device 10, 20, the second life saving equipment may for example be air inflating balloon/avalanche airbag for avalanche buoyancy, container comprising compressed oxygen, airbag for body protection, body heating equipment optionally powered by the power resource 5 of the breathable air quality improvement device 10, 20, or other.

FIG. 6 is a flow diagram explaining the method of operation for on optional embodiment of the invention wherein once the breathable air quality improvement devices 10, 20 is turned on the control switch activation 200 awaits either an automatic emergency detector 201 input signal for activation or a manual controlled signal from a switch 202. When such input signal is received, the control unit may initiate operation by performing a self-test and/or reading power status 203 of the battery. If the invention comprises more than one breathable air quality improvement devices 10, 20, the controller will select which devices 204 is to be activated. This decision may be influenced by the power level or other sensor inputs. If the pump(s) can be ran at different capacity levels, the data read by sensors and power level may additionally be evaluated for defining at which level 205 the pump is to operate. If pump level is to be changed, the pump is then instructed 206 to run at the new level. The controller 6 reruns the self-test to pump activation operations 203-206 at a preset time interval, for example-every 30 second.

One regime controlling the pump capacity level setting may consider lowering the power consumption by only providing enough breathable air as to barely keep the person alive in order to maximize the lifetime of the power source. If sensors detect disturbing heartbeat, the rate of breathable air may be increased for a period of time. Another regime may include communication with a remote rescue group, which may estimate the time of arrival, and the power consumption may be averaged over the time until estimated rescue.

The breathable air quality improvement device 10, 20 may provide advantageous and lifesaving aid in further environments than in the avalanche/snow environments discussed above. Such environments may for example be: tight environments wherein workers executing work with limited air supply such as well, pipes, crawling spaces, caves, manure bin, and other.

FIG. 7 illustrates a system embodiment of the invention wherein the controller 6 comprises a wireless communication unit able to communicate a beacon 106 searchable by a searching party 105. The wireless communication unit may also be able to transmit 103 sensor 8 readings, in order for the searching party to be able to take intelligent decisions, such as send for emergency transport 107. The communication unit may further be able to communicate with a cloud or wide area network 100, and through this communicate 102 with a server service 101, the searching teams 105, the transport 107 or a local alarm station 104. This can typically be an emergency service able to react to distress signals, and which may communicate 102 with appropriate control rescue teams 105 and emergency transportation 107.

Communication transfer medium 102, 103, 106 may be one of, wireless LAN or WAN, Bluetooth, WIFI, mobile network, radio communication, or other communication medium.

A further system feature may comprise a local alarm station 104 provided on site, for example at selected mountain locations. Each invention device 10, 20 may at preset intervals communicate 103 with a local alarm station 104 to identify presence and no-distress signal. When an emergency situation is detected, the local alarm station 104 may be programmed to provide a list of persons out of danger, and who's in a danger zone.

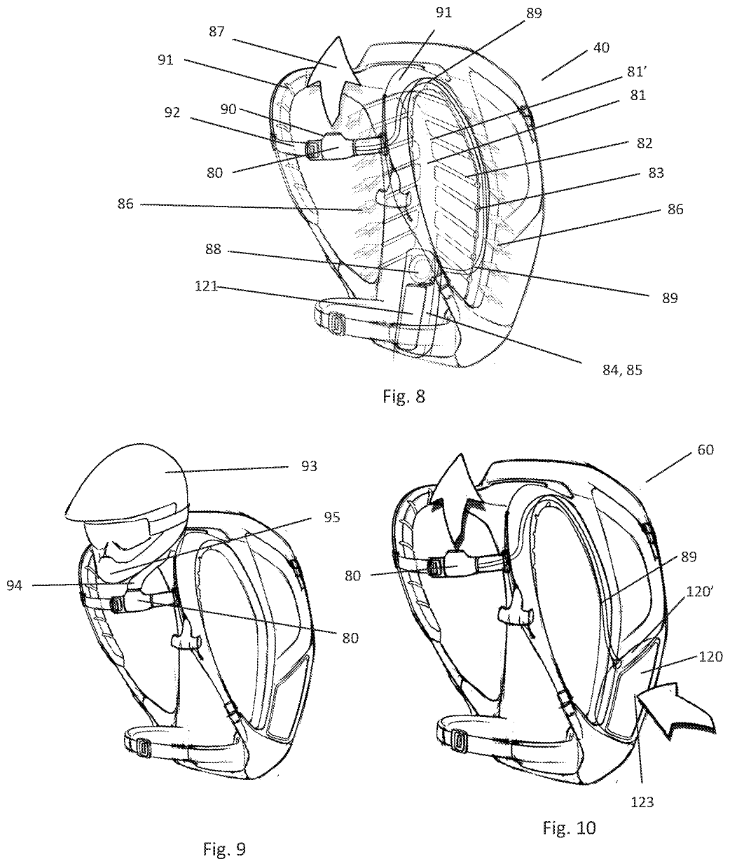

A further embodiment of the invention is illustrated in FIG. 8. An inlet channel is integrated with a frame, such as for example the back plate of a backpack 40, wherein the inlet channel is constructed as a plurality of distributed inlet channels 82 comprising at their most peripheral end corresponding inlet openings 83 which are set apart arranged in a distributed pattern enabling air to be collected from the different surroundings of each of the inlets opening 83. Thereby, enabling collecting air from a larger volume of surrounding area than if the inlet was only in one location. The plurality of the distributed inlet channels 82 is in its central end coupled to a pump 85, optionally via a central inlet channel 81. Each distributed inlet channel 82 may connect at its peripheral end the corresponding air inlet (83) to the central inlet channel 81 in a connecting junctions 81′, the central inlet channel 81 may have one or more connecting junctions 81′ connecting to each of, or group of, distributed inlet channels (82). In one embodiment some or all of the central inlet channel 81 and/or the plurality of the smaller distributed inlet channels 82 and corresponding inlet openings 83 may be constructed for and be filled with a formable air permeable foam material, such that the air transported by the channels is at the same time filtered. Filter properties may vary depending on need, pump capacity and other. The formable foam material may also partially contribute to maintain the form of the channels 81, 82, and thereby also lower the requirements to the material used in the walls of the channels 81, 82. For example it could suffice to use channel wall material of light weight poly based materials, light weight woven airtight material or the like.

In the example of integrating the central inlet channel 81 and the plurality of the smaller inlet channels 82 in the frame of a backpack 40 as shown in FIG. 8, the smaller inlets are arranged in the periphery of the back plate, and the inlet openings 83 are either on the side of the back plate of the back pack 40, or in the close vicinity of the side edge of the back plate on the side facing towards the person carrying the backpack 40. Each inlet opening 83 is coupled to the central inlet channel 81 by the distributed inlet channel 82, such that air easily can be sucked into the central inlet channel 81 from each inlet opening 83.

The pump 85 may be integrated with a battery in an enclosed casing 84 attached to the inlet openings 83 via the distributed inlet channels 82 and the central channel 81. The pump 85 will when activated generate a vacuum in the distributed inlet channels 82 and the central channel 81, combined forming or acting as a chamber, and by that suck air from the surrounding via the inlet openings 83 and through the distributed inlet channel 82 and the central channel 81. The combined strength of the channels 81, 82 and the optional filling comprising the formable foam material must be able to maintain a form sufficient to withstand the vacuum without collapsing.

A further advantage of the embodiments shown in the figures is achieved by integrating an air supply pipe 89 for transporting air from the pump 85 to the facial area in the backpack 40 and one or more of shoulder harness 91, sternum strap 92, stabilizer straps or the like. Thus the air supply from the pump 85 may be transported through the air supply pipe 89 wherein the air supply pipe 89 will be concealed in the back plate, and/or shoulder harness, and/or sternum strap, and/or stabilizer straps of the backpack 40, and thereby be protected from damage from the surroundings.

An outlet device 80 providing an outlet opening 90 for the air supply pipe 89 may be provided at the end of the air supply pipe 89, at the opposite end of the air supply pipe 89 than the end being connected to the pump 85. The outlet 80 being arranged close to a carrier's facial area. The outlet device 80 may be provided with further outlet filtering material to ensure the outlet is not packed with snow and ice. The outlet filter material may additionally be provided with a heating device (not shown) to prohibit icing clogging the air outlet opening 90.

In order to facilitate providing improved air at more precisely defined enclosures, such as when the user of the air quality improvement device wears a full face helmet 93 and air must be supplied inside the helmet, a pipe extender 94 may be connected, for example by a quick snap locks, in one end to the outlet opening 90 of the outlet device 80, and in the other end connected to the inside of the helmet 93, for example to a helmet outlet device (not shown). In one embodiment the helmet outlet device may be integrated in the helmet, for example in the jaw protection portion 95.

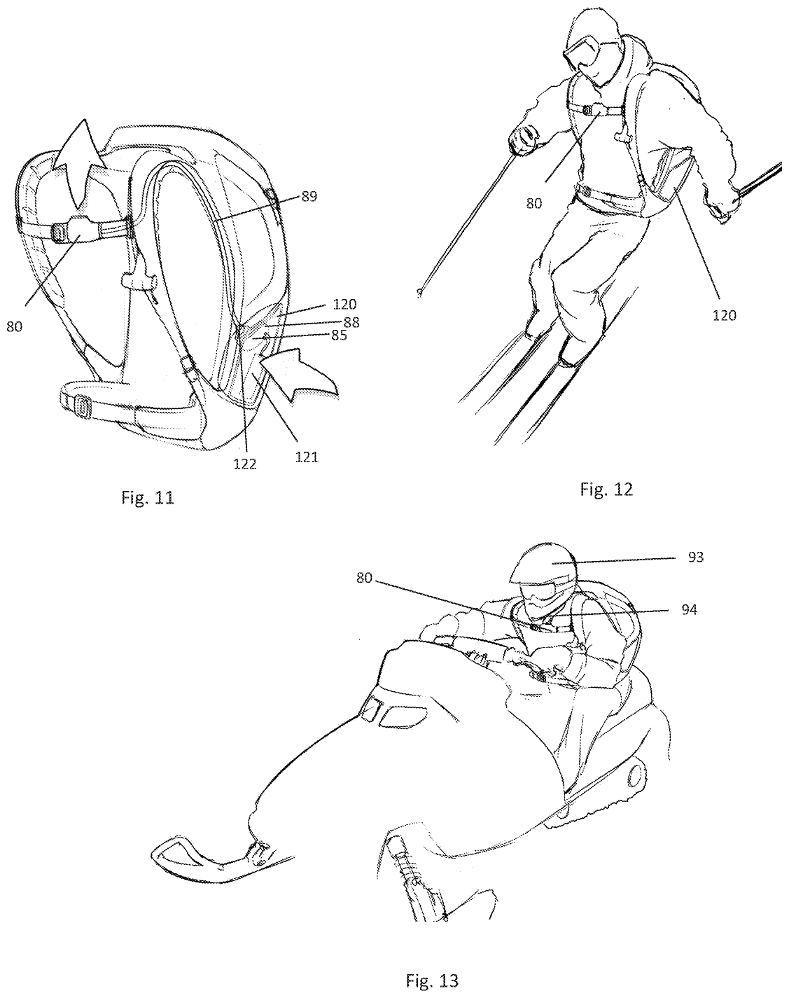

In a further embodiment, the pump, battery and distributed inlet channels and openings as shown in FIG. 8 may be be comprised in a combined pump unit 120 comprising a chamber 120′, a pump 85, a battery, an air inlet being comprised of the opening 123 of the chamber 120′ facing towards the surroundings, and a filter, all in one device adapted for integration into the side of a backpack or the like as shown in FIG. 10 and FIG. 11. In this latter embodiment parts of or the hole side of the carrying device, such as the backpack 40, may be used for encompassing the inlet opening. An integrated side cover providing an air permeable barrier between the inlet of the combined pump unit may advantageously be provided, the side cover providing an extra protection towards external forces and items. The pump 85 in the pump unit 120 then will suck air from the surrounding into the pump inlet 82 from the inlet opening, and feed the air supply pipe 89 which is connected to the outlet 122 of the pump 85 and which transports the air to the outlet device 80. Further air filtering and support in the chamber may be provided by filling the chamber partially or completely with a formable air permeable foam material, thus providing a further barrier for debris, snow, fluids and other particles to be sucked into the pump.

The device shown in FIG. 8 may be implemented in a wearable jacket provided with a back plate for encompassing the inlet channels and the central channel, or a carry on back plate (not shown), or the like.

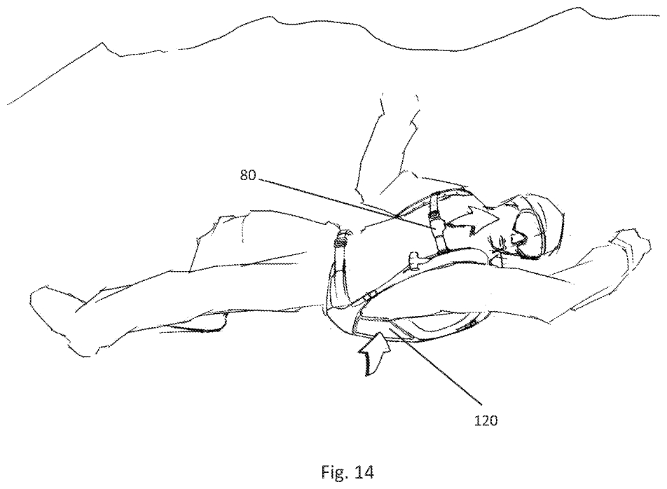

The use scenarios shown in FIGS. 12, 13 and 14 all show the latter embodiment of the pump unit 120, for convenience of the drawing clearly identifying this unit. It is however the inventors intention that the embodiment shown in FIG. 8 comprising the inlet openings 83 via the inlet channels 82 and the central channel 81 integrated in the back frame of for example the back pack could be used in the scenarios shown where a downhill skier wears the back pack as shown in FIG. 12, or the version shown in FIG. 13 worn by a snowmobile driver also using a helmet 93 and comprising the pipe extender 94 connected in one end to the outlet device 80, or as shown in FIG. 14, where a person has been buried in an avalanche.

The following embodiments may define earlier version of the device in present disclosure wherein: the device 10, 20 for improving the breathable air quality in an environment, comprise:
at least one inlet 4,
at least one pump 3,
at least one power resource 5,
a controller 6, and
at least one outlet 1 wherein
the at least one inlet 4 is connected to a pump inlet 31 of the pump 3, and
the at least one outlet 1 is connected to a pump outlet 32 of the pump 3,
the pump will, when activated, pump air from the inlet 4 to the outlet 1.

The device 10, 20 wherein the connection between the at least one inlet 4 and the pump inlet 31 further comprise an inlet pipe segment 7′ for enabling a more distant arrangement of the inlet 4 relative the pump inlet 31.

The device 10, 20 wherein the connection between the at least one outlet 1 and the pump outlet 32 further comprise an outlet pipe segment 7′″, 7′″ for enabling a more distant arrangement of the outlet 4 relative the pump outlet 32.

The device 10, wherein any of the pipe segments 7′, 7″, 7′″, inlet 4, outlet 1 or the pump 3 is further comprising a filter 2 for filtering the air supplied by the device 10.

The device 10, 20 wherein the filter 2 is a CO₂ filter for removal of CO₂ from the air supplied by the device 10.

The device 10, 20 wherein the controller 6 comprise an automatic activation unit 11 for setting and controlling an operating mode of the pump 3.

The device 10, 20 further comprising one or more sensors 8, wherein the sensors are sensitive to one or more of: movement caused by an avalanche, CO₂ level above preset threshold, weight load/pressure, g-forces, power resource level such as battery capacity reserve, or sensor input crossing activation threshold such as: an oxygen content in a person's blood stream, heart rate or body temperature, and
the one or more sensors 8 is connected via a sensor input interfaces 8′ to the automatic activation unit 11 of the controller 6, wherein the controller 6 comprise a program for monitoring the sensor 8 readings and for controlling the operation mode of the device 10, 20 accordingly.

The device 10, 20 wherein automatic activation unit 11 comprise a manual switch 11′, wherein the manual switch 11′ can override the sensor inputs 8 and be used to manually activate the pump 3 at selected operation modus.

The device 10, 20 wherein the inlet 4 further comprising an inlet protection device 4′ for protection of the inlet 4 against being clogged by snow, water or other substances.

The device 10, 20 wherein the inlet protection device 4′ is formed by a light weight protection mesh.

The device 10, 20 wherein the mesh being constructed of one of hard plastic or carbon material.

The device 10, 20 wherein the inlet protection device 4′ may be filled with a gas permeable material.

The device 10, 20 wherein the gas permeable material is a polyurethane sponge.

The device 10, 20 further comprising a feedback duct 110 for providing air from the outlet 1 surrounding environment to be fed into the pump 3 and hence back through the outlet 1.

The device 10, 20 further comprising a bypass duct 111 for bypassing the filter 2.

The device 10, 20 wherein the device is arranged in a backpack 40 assembly, wherein the inlet 4 and inlet protection device 4′ is arranged at the lower end of the backpack 40, and the outlet 1 is arranged to be arranged close to the mouth and nose region of a bearer.

The device 10, 20 wherein the device is arranged in a bag or backpack 40 assembly, wherein the inlet 4 and inlet protection device 4′ is arranged in the backpack 40 or bag assembly, and the inlet 4 comprises an extendable inlet pipe 7′ or the outlet 1 comprise an extendable outlet pipe 7″, 7′″ such that the device 10, 20 could be arranged such that the inlet 4 is arranged away from a person, and the outlet 1 is arranged close to the face area of the person.

The device 10, 20 further comprising a wearable device, the wearable device 114 holding the outlet 1 such that it may be in a position close to nose/mouth of person wearing the device 10, 20.

The device 10, 20 further comprising an alarm 112, wherein the alarm 112 can be activated by the controller 6 if a detector 8 detects too high CO₂ level close to the outlet 1, the power resource level is below a preset threshold, or any detector detects levels outside preset acceptable levels.

The device 10, 20 further comprising an additional inlet 115 for providing oxygen to the pump 3 from an inflated balloon/avalanche airbag.

The device 10, 20 further comprising an oxygen filled container 116 for providing oxygen to the pump 3 from the oxygen filled container 116.

The device 10, 20 wherein the controller 6 further comprising a communication device, the communication device being able to transmit device 10, 20 status to a remote communication unit 101, 104, 105, 107.

The device 10, 20 wherein the communication device being able to receive operation instructions from a remote communication unit 101, 104, 105, 107.

A system embodiment for providing extended life support to avalanche victim, wherein the system comprises one or more of the devices 10, 20, the system further comprise a remote communication unit 101, 104, 105, 107, and a communication transfer medium 102, 103, 106.

The system wherein the remote communication unit 101, 104, 105, 107 is one of local alarm station 104 able to identify presence and no-distress signal of the devices 10, 20, remote server 101 able to monitor and communicate with other remote communication units 101, 104, 105, 107, search party 105 able to locate device 10, 20 merely by receiving a beacon 106 broadcasted by a device 10, 20, or an emergency transport 107.

The system wherein the devices 10, 20 if further combined with other lifesaving equipment.

The system wherein other lifesaving equipment is one or more of air inflating balloon/avalanche airbag for avalanche buoyancy, container comprising compressed oxygen, airbag for body protection, body heating equipment.

A method for improving the breathable air quality in an environment using the device 10, 20 the method comprising the following step:
the user turning on the device 10, 20;
activating the device 10, 20 upon one of automatic emergency detector 201 or the manual switch 202 being activated;
starting the pump 206.

The method wherein the step starting the pump 206 comprise of one or more of the following steps being performed before starting the pump 206:
a) the controller 6 of the device 10, 20 performing a successful self-test and reading power source status and/or sensors status 203;
b) controller 6 selecting which device 10, 20 to activate 204,
c) controller 6 selecting pump level 205 of selected pump 3,
   starting the pump 206 at selected pump level, and
   repeating step a to c at preset intervals for adjusting pump level or change device 10, 20.

It shall be understood that the embodiments only describe the principle of the invention, and that there may be additional ways to implement the present invention. It is the associated claims that shall define the protection scope of the present invention.

1. A survival device for feeding a steady supply of breathable air into an environment, comprising:
a housing, the housing comprising:
at least one inlet,
at least one pump/fan,
at least one power resource,
a controller, and
the survival device further comprising:
at least one outlet wherein
the at least one inlet is connected with a pump/fan inlet, and
the at least one is connected with the at least one pump/fan outlet via an air supply pipe, the air supply pipe having a rigid form factor, the outlet is further comprising an internal stiffening element for providing a stable and flexible form factor of the outlet.

2. The survival device according to claim 1, wherein the at least one outlet further comprise arranged on its outer end:
attachment means for fixedly arranging the at least one outlet to a position close to the users facial area.

3. The survival device according to claim 2, wherein the attachment means comprise:
gripping connectors for being arranged around a harness/strap.

4. The survival device according to claim 1, further comprising:
an activator for activation of the pump/fan at an available/selected operation mode.

5. The survival device according to claim 4, further comprising:
an activation lever,
a bracket,
a wire inside a wire sleeve,
the wire sleeve being in a first end held by a wire sleeve space of a wire conduit element coupled to a bracket,
the wire being connected in a first end to a fastening element comprised in the activation lever, and
the wire sleeve being in a second end connected to the housing,
the wire being connected in a second end to a connector being comprised in the housing,
the connector being connected to the activator, such that when the activation lever is pulled relative the bracket, the pulling movement is transferred to the wire inside the sleeve to the connector and to the activator.

6. The survival device according to claim 5, wherein the activation lever and the wire conduit element further comprises space for additional wires and wire sleeves for controlling activation of additional devices.

7. The survival device according to claim 1, wherein: the housing comprising at least two battery connectors, and
a battery enclosure lid.

8. The survival device according to claim 1, further comprising one or more sensors, wherein the sensors are sensitive to one or more of: movement caused by an avalanche, CO₂ level above preset threshold, weight load/pressure, g-forces, power resource level such as battery capacity reserve, or sensor input crossing activation threshold such as: an oxygen content in a person's blood stream, heart rate or body temperature, and
the one or more sensors is connected via a sensor input interfaces to the automatic activator of the controller, wherein the controller comprise a program for monitoring the sensor readings and for controlling the operation mode of the device accordingly.

9. The survival device according to claim 1, wherein the automatic activator comprise a manual switch/connector, wherein the manual switch/connector can override the sensor inputs and be used to manually activate the pump/fan at selected operation modus.

10. The survival device according to claim 6, wherein the additional wires and wire sleeves is used for controlling the activation of an inflating balloon/avalanche airbag.

11. The survival device according to claim 4, further comprising a safety tether being coupled to the activator to activate the survival device when the safety tether being pulled.

12. The survival device according to claim 1, wherein the controller further comprise a communication device, the communication device being able to transmit device status to a remote communicator.

13. The survival device according to claim 1, further comprising a comprehensive set of self-test programs comprising tests to check one or more of:
battery status
HW status
self-test control
fan status
operation status
communication status.
and further signals for identify self-test program running and result.
